(19) United States
(12) Patent Application Publication
(10) Pub. No.: US 2011/0093714 A1
(43) Pub. Date: Apr. 21, 2011

(54) SYSTEMS AND METHODS FOR ASYMMETRIC CRYPTOGRAPHIC ACCESSORY AUTHENTICATION

(75) Inventors: Stephan Schaecher, Munich (DE); Harald Hewel, Aichach (DE); Markus Gueller, Stadtbergen (DE)

(73) Assignee: Infineon Technologies AG, Neubiberg (DE)

(21) Appl. No.: 12/582,362

(22) Filed: Oct. 20, 2009

(51) Int. Cl. H04L 9/32; H04L 9/14; H04L 9/28

(52) U.S. Cl. 713/176; 713/168; 713/181

(57) ABSTRACT

Embodiments relate to systems, methods and devices for asymmetric cryptographic authentication. In an embodiment, a system includes an accessory comprising an authentication chip, the authentication chip comprising a public authentication key, a private authentication key and data signed by a private verification key; and a device comprising a public verification key forming a verification key pair with the private verification key, the device configured to read the data and public authentication key from the authentication chip, verify the data and the public authentication key using the public verification key, and authenticate the accessory for use with the device using the public authentication key if verified.

### TECHNICAL FIELD

The invention relates generally to accessory authentication in personal electronic devices and more specifically to asymmetric cryptographic accessory authentication.

### BACKGROUND

The use of encryption for authentication of devices is generally known. Conventionally, a message, or “challenge,” is sent from a system or device to an object to be authenticated, and a message-dependent response is sent by the object to the system in reply. The system then evaluates the response to determine whether the response was sufficient to authenticate the object.

Such a method may be used, for example, to verify components of a system or device, including components that are removable, replaceable or available after-market. For example, a battery for an electronic device such as a mobile phone or a camera can be authenticated to determine whether it is an authorized and compatible battery. If the battery is successfully authenticated, normal operation ensues. In an attempted use of a battery that is not successfully authenticated, no operation or only limited operation could be authorized as a result of the failed authentication procedure. For example, charging of the battery could be disabled.

Disadvantageously, conventional authentication methods typically require significant processing and memory resources such that authentication using encryption has not been economically feasible in many small and/or low-cost devices. Further, conventional authentication approaches often use symmetric authentication methodologies. While secure, these methodologies can be complex and also run the risk of the single key being compromised or leaked, a particular problem for widely distributed consumer electronic devices.

### SUMMARY OF THE INVENTION

Embodiments relate to systems, methods and devices for asymmetric cryptographic authentication. In an embodiment, a system comprises an accessory comprising an authentication chip, the authentication chip comprising a public authentication key, a private authentication key and data signed by a private verification key; and a device comprising a public verification key forming a verification key pair with the private verification key, the device configured to read the data and the public authentication key from the authentication chip, verify the data and the public authentication key using the public verification key, and authenticate the accessory for use with the device using the public authentication key if verified.

In another embodiment, method comprises configuring a first device with an authentication chip having a public authentication key, a private authentication key and data signed by a private verification key; storing a public verification key on a second device; communicatively coupling the first device to the second device; reading the data and the public authentication key from the first device by the second device; determining whether the data and the public authentication key are verified using the public verification key; and determining whether the first device is authenticated for use with the second device using an elliptic curve cryptographic algorithm if the data and the public authentication key are verified.

In a further embodiment, a semiconductor chip is adapted to be embedded in a first device and comprises a memory comprising a private authentication key, a public authentication key, and data signed by a private verification key, wherein the private authentication key is stored in a secure portion of the memory; and a communication interface configured to communicate with a second device comprising a public verification key using an asymmetric cryptographic technique.

In yet another embodiment, a method comprises reading a public authentication key from a first device by a second device; verifying the public authentication key using a public verification key stored on the second device and data stored on the first device and signed by a private verification key; encrypting a challenge with the public authentication by the second device; sending the encrypted challenge to the first device; decrypting the challenge using a private authentication key by the first device; sending a response by the first device to the second device; and evaluating the response by the second device to determine whether the first device is authenticated.

### BRIEF DESCRIPTION OF THE DRAWINGS

The invention may be more completely understood in consideration of the following detailed description of various embodiments of the invention in connection with the accompanying drawings, in which:

FIG. 1 is a block diagram of a device according to an embodiment.

FIG. 2 is a block diagram of an object including an authentication chip according to an embodiment.

FIG. 3 is a flowchart of an authentication process according to an embodiment.

FIG. 4 is a flowchart of a verification process according to an embodiment.

FIG. 5 is a block diagram of a signature generation process according to an embodiment.

FIG. 6 is a block diagram of a verification process according to the embodiment of FIG. 5.

FIG. 7 is a block diagram of a signature generation process using a template according to an embodiment.

FIG. 8 is a block diagram of a verification process according to the embodiment of FIG. 7.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

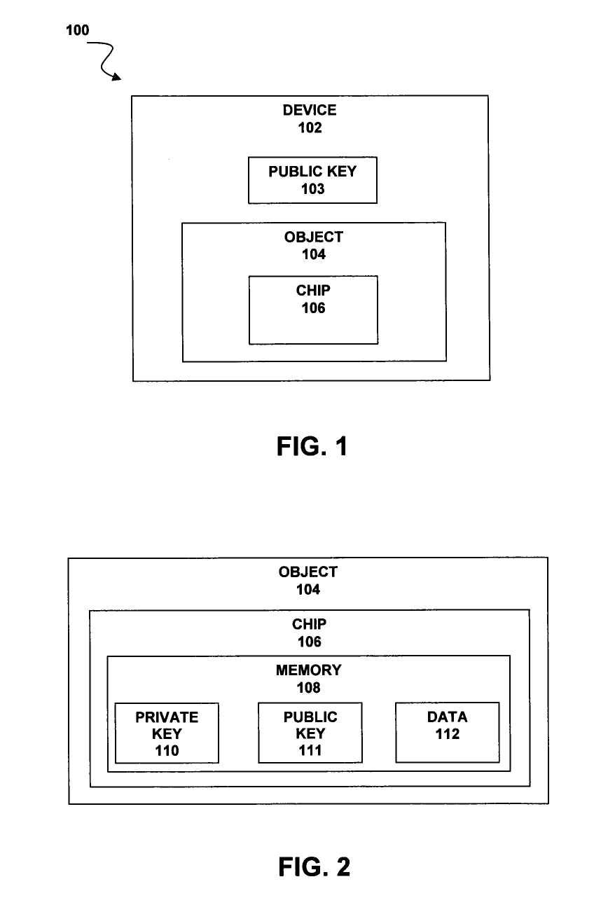

FIG. 1 depicts an embodiment of an authentication system 100. Authentication system 100 includes a device 102, such as a mobile phone; personal digital assistant (PDA); camera; MP3 player, gaming system, audio and/or video system, or other entertainment device; computer, computer system, network or computing device; printer, scanner or other digital imaging device; medical device or equipment or diagnostic supply; or some other electronic or computer device. Device 102 includes a public verification key 103, which will be described in more detail below, and an object 104 with which device 102 operates in cooperation. In embodiments, object 104 can comprise a battery; an accessory, including earphones, a headset, speakers, a docking station, a game controller, a charger, a microphone and others; a printer ink cartridge; a computer or computer system component, network device, peripheral, USB or other storage device; part or other component, and for which authentication is required or desired. In embodiments, object 104 is a replacement component, such as an aftermarket accessory or battery, though object 104 can also be an original part. Object 104 can be provided by the same manufacturer or provider as device 102 or by some other party, such as an authorized manufacturer and/or distributor of replacement and aftermarket parts and accessories.

Object 104 is depicted in FIG. 1 as operating within or as part of device 102, such as in an embodiment in which device 102 comprises a printer and object 104 comprises an ink cartridge. In other embodiments, object 104 is external to device 102, such as when device 102 is a mobile phone and object 104 is a wired or wireless earpiece. These embodiments are examples only, and many other device/object combinations and pairings can be used in other embodiments.

Referring also to FIG. 2, object 104 comprises an authentication chip 106 in an embodiment. Authentication chip 106 comprises a semiconductor chip in an embodiment and includes memory 108. Memory 108 is non-volatile memory in an embodiment, configured to store data objects, for example a private authentication key 110 and a public authentication key 111 stored in a secure portion of memory 108. In other embodiments, memory 108 comprises other circuitry, fuses, elements or other storage means configured to retain data and information. Public authentication key 110 and private authentication key 111 form an authentication key pair. Memory 108 can also store one or more of a unique ID and/or serial number of object 104, application-specific data and other information, together represented in FIG. 2 by data 112. Additional data objects which can be stored in memory 108 include a unique portion of an authentication certificate, described in more detail below.

In an embodiment, the functionality and features of authentication chip 106 are realized as one or more system on chip components of object 104 to achieve cost or size savings. For example, object 104 can comprise a BLUETOOTH headset, which often is of small size and therefore may not be able to accommodate an additional chip 106. Instead, the features and functionality are integrated on an existing chip in the headset, saving space and possibly also costs. In such an embodiment, a manufacturer of the headset or other device comprising object 104 can be provided with, for example, a VHDL netlist for integration into an existing controller or processor of the headset or other device in place of a discrete authentication chip 106, which little or no change in the features, functions and security thereby provided.

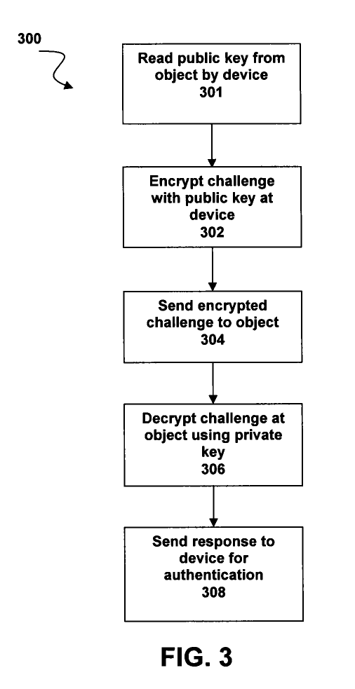

Referring to FIG. 3, a method 300 can be implemented between device 102 and object 104 to determine whether object 104 is authenticated for use with or by device 102. At 301, device 102 reads public authentication key 111 from object 104. Device 102 now has two public keys: public verification key 103 and public authentication key 111.

Before using public authentication key 111, however, device 102 determines whether public authentication key 111 is verified or genuine. In a conventional system using global or constant public and private key pairs for devices, verification can be accomplished by simply comparing the global key (public authentication key 111 received from object 104) with the same global key or a hash thereof stored on device 102. Use of global keys, however, does not provide the highest levels of security, as the global keys are vulnerable to hacking or other corruption. In embodiments, therefore, unique public and private keys are used for each device, and this process is described in more detail herein below.

At 302, and after verifying public authentication key 111, device 102 uses public authentication key 111 to encrypt a challenge. In an embodiment, the challenge comprises a random number. In another embodiment, the challenge also includes additional data. In embodiments, the encryption is carried out according to an asymmetric encryption methodology, for example an elliptic curve cryptographic algorithm. In another embodiment, an RSA cryptographic algorithm or some other cryptographic algorithm is used.

At 304, the encrypted challenge is transmitted from device 102 to object 104. In embodiments, the challenge can be transmitted wirelessly, such as by radio frequency (RF), or by wire, such as by a power line or other wire connection between device 102 and object 104. At 306, object 104 decrypts the received encrypted challenge using private authentication key 110. At 308, object 104 sends the decrypted challenge as a response to device 102, and device 102 determines whether the response is appropriate such that object 104 can be authenticated.

After method 300, device 102 can retain both public keys 103 and 111, or device 102 can delete public key 111 that was read from object 104. Retaining both keys can save time and calculations in the future, while deleting one key can free memory space.

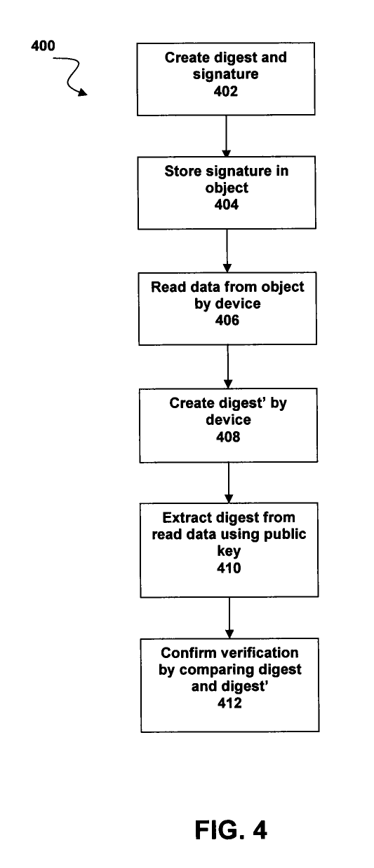

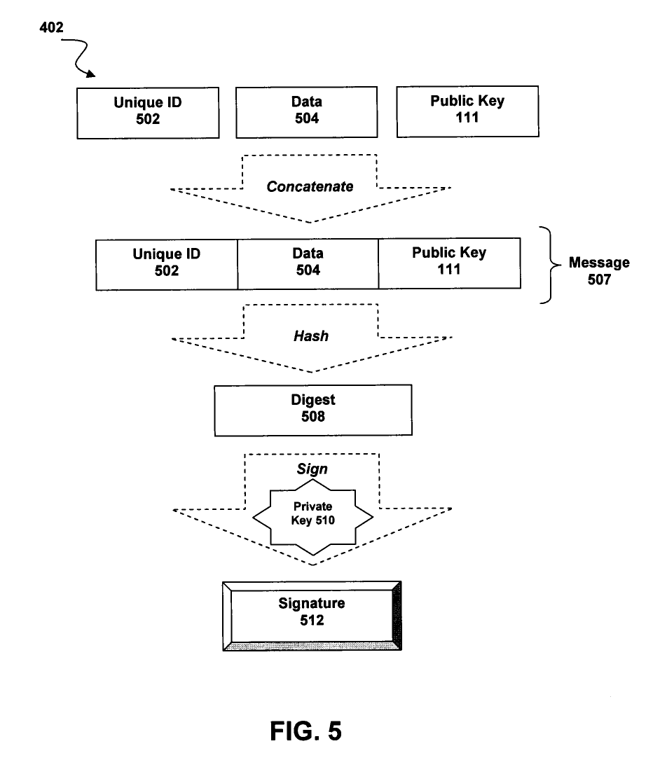

In an embodiment, and referring to FIG. 4, a certificate process 400 is used with process 300 to enable use of unique public and private key pairs with devices and objects. At 402, a digest is created by a certificate authority. The certificate authority can be a manufacturer, fabricator, distributor or other entity related to chip 106 and/or object 104. A private verification key 510 (shown in FIG. 5) is held by the certificate authority and forms a verification key pair with public key 103 stored on device 102.

Creation of the digest by the certificate authority is shown in more detail in FIG. 5. First, a message 507 is created by concatenating a unique device identifier 502 related to object 104 and/or chip 106, such as a serial or ID number or code; public authentication key 111; and data 112. Message 507 is hashed to create a digest 508. In an embodiment, an SHA-1 cryptographic hash algorithm is used, while other hash algorithms and techniques are used in other embodiments, for example SHA-256.

Digest 508 is signed using private verification key 510 of the certificate holder to create a signature 512. In an embodiment, an elliptic curve cryptographic algorithm is used to sign digest 508. Advantages of an elliptic curve cryptographic algorithm include shorter keys and fewer calculations because of the shorter keys, which can be beneficial in small, low-cost and/or embedded objects having less processing capacity. In another embodiment, an RSA cryptographic algorithm or some other cryptographic algorithm is used.

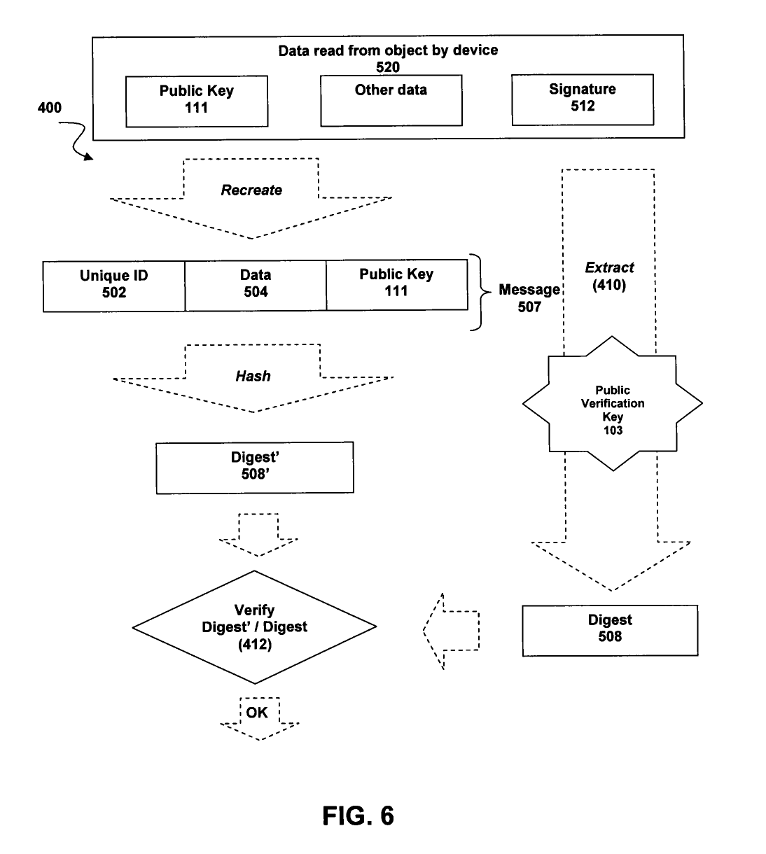

Referring to FIGS. 4-6, signature 512 is stored in memory 108 of object 104 at 404. In an embodiment, this is carried out by the certificate authority. In another embodiment, this is done by a manufacturer or other entity related to object 104. The certificate authority and the manufacturer can be the same or different entities, but in general access to and handling of the signature is carefully controlled to improve security.

When object 104 is first attempted to be used with a device 102, device 102 must authenticate object 104 and verify that any data, information, content, media or other quantity originating from object 104, or object 104 itself, are legitimate. Accordingly, device 102 reads signature 512 and other data 520 from object 104 at 406. As part of this read, device 102 receives public authentication key 111 from object 104 as previously described, but device 104 cannot know whether public key 111 is corrupted or has been compromised and thus must verify the key.

This can be done using signature 512. Device 102 first recreates message 507 from data 520 and hashes message 507 according to the same algorithm used to create digest 508, thereby creating digest′ (508′) at 408. At 410, device 102 then extracts the original digest 508 from signature 512 read from object 104 using public verification key 103, which is intended, absent tampering or corruption, to correspond to private verification key 510 used to originally create signature 512. If the extraction is successful, device 102 compares digest′ (508′) with digest 508 at 412. If digest 508 and digest′ (508′) match, device 102 has verified that the data and information received from object 104 is uncorrupted and can use public authentication key 111 received from object 104 to authenticate object 104 according to process 300.

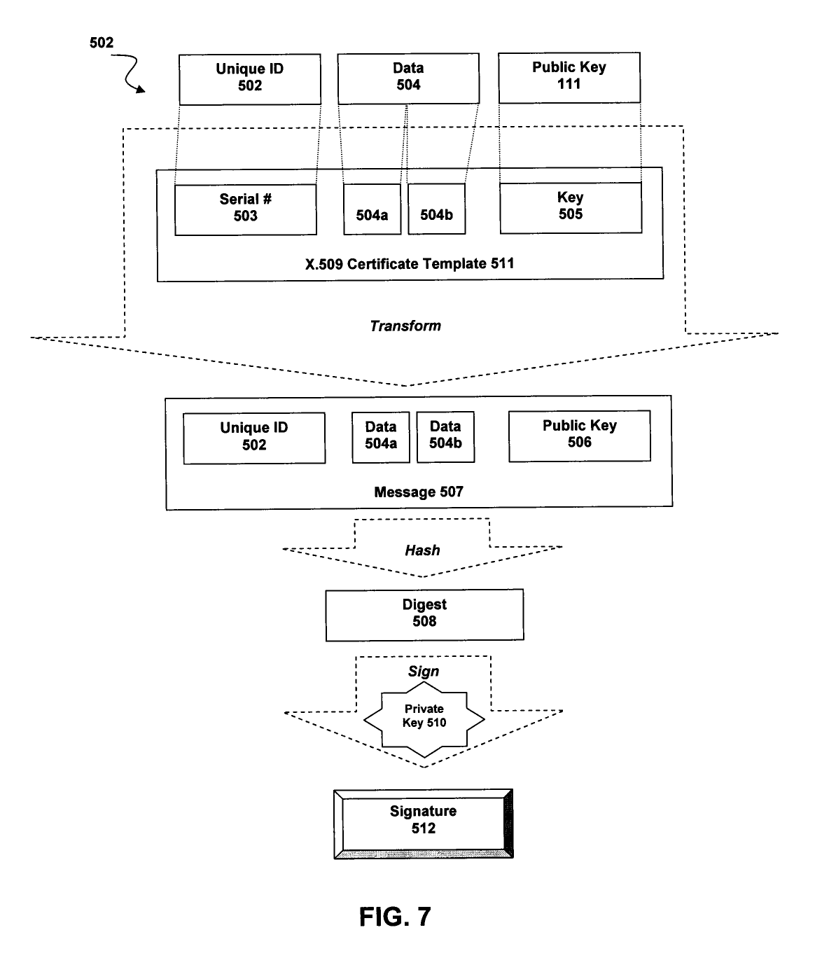

FIG. 7 is another depiction of the creation of the signature using a standardized certificate template format. Mapping the certificate to a standard certificate format used in the industry, such as the ITU-T standard X.509 for cryptographic public key infrastructure, enables easy integration of chip 106 with standardized infrastructure components, such as key revocation servers, content providers and the like. According to the embodiment of FIG. 7, unique ID 502, data 504 and key 111 are mapped to a certificate template 511. In an embodiment, template 511 is an ITU-T standard X.509, requiring a serial number 503, which can be extracted or determined from ID 502; data slots 504a and 504b, to which optional data 504 can be mapped; and a key segment, to which public key 111 can be mapped. Fields which were shortened in length or for which certain bits were removed can be filled to recreate original field lengths as required by the template. Information and data remains consistent, and requirements of standardized certificates are met to provide infrastructure and compatibility advantages. The result of the mapping and transformation is message 507, which includes the variable content of the ID 502, data 504 and key 111 fit to the standard template format of template 511.

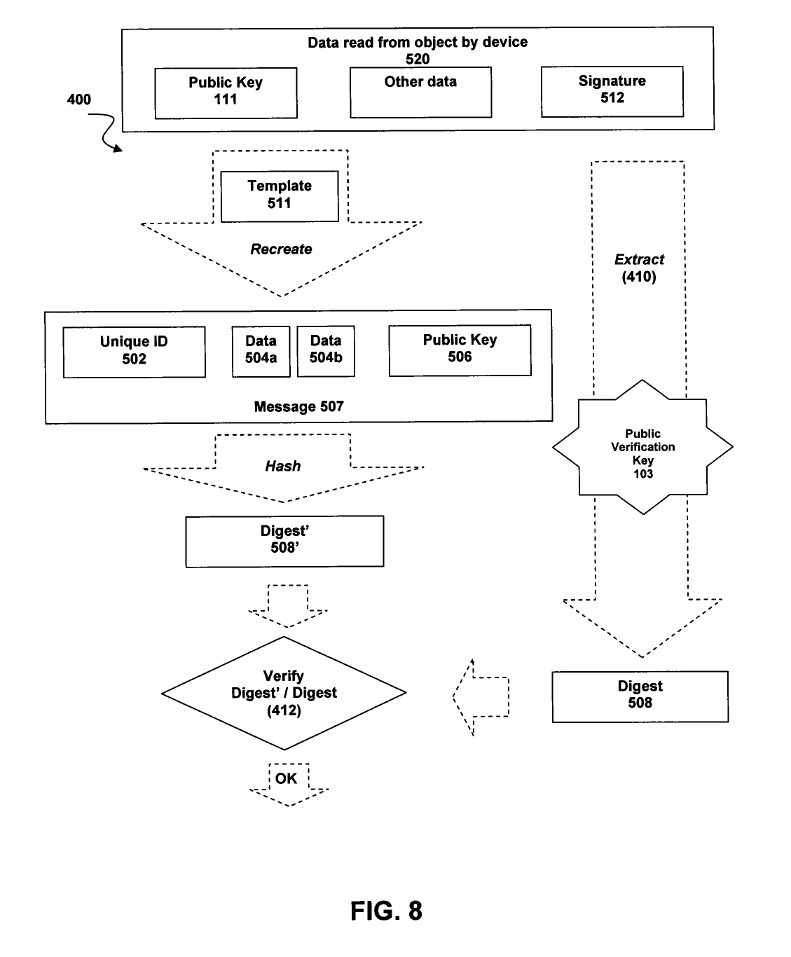

The remainder of the process is the same as or similar to that described above with respect to FIGS. 4-6, with the exception of the recreation of the message. As depicted in FIG. 8, device 104 recreates message 507 according to certificate template 511 before hashing to create digest′ 508′.

Embodiments provide secure authentication of accessories, batteries, parts and other objects at a lower cost suitable for price-sensitive applications. Additionally, embodiments provide recovery action options in the event of hacking or key misuse by key blacklisting. Thus, if hacking of a public key is discovered, that key can be revoked or “blacklisted” and disabled globally, rather than having to block each single key in conventional approaches. This provides enhanced security and more efficient key management. Logistical improvements and efficiencies are also realized in that the device need not be preconfigured with the correct public key for a particular object, as the public key is extracted from the certificate stored in the object upon first use according to an embodiment. The overall security level is thereby enhanced, providing cost-effective authentication.

Various embodiments of systems, devices and methods have been described herein. These embodiments are given only by way of example and are not intended to limit the scope of the invention. It should be appreciated, moreover, that the various features of the embodiments that have been described may be combined in various ways to produce numerous additional embodiments. Moreover, while various materials, dimensions, shapes, implantation locations, etc. have been described for use with disclosed embodiments, others besides those disclosed may be utilized without exceeding the scope of the invention.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as understood by persons of ordinary skill in the art.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

What is claimed is:

1. A system comprising:
an accessory comprising an authentication chip, the authentication chip comprising a private authentication key, a public authentication key and data signed by a private verification key; and
a device comprising a public verification key forming a verification key pair with the private verification key, the device configured to read the data and public authentication key from the authentication chip, verify the data and the public authentication key using the public verification key, and authenticate the accessory for use with the device using the public authentication key if verified.

2. The system of claim 1, wherein the authentication chip is a semiconductor chip.

3. The system of claim 1, wherein the public authentication key, the private authentication key and the data are stored in a non-volatile memory of the authentication chip.

4. The system of claim 1, wherein the device uses an elliptic curve cryptographic algorithm to authenticate the accessory.

5. The system of claim 1, further comprising a certificate authority entity controlling the private verification key.

6. The system of claim 1, wherein the device and the accessory are a pair selected from the group consisting of: a mobile phone and a battery; a mobile phone and a mobile phone accessory; a printer and a printer cartridge; a gaming unit and a gaming unit controller; an electronic device and a battery; an electronic device and an accessory; a computer device and an accessory; a computer device and a battery; a computer device and a peripheral device; a network and a networking device; a media device and a battery; a media device and an accessory; a medical device and a battery; a medical device and an accessory; a personal digital assistant (PDA) and a battery; and a PDA and an accessory.

7. A method comprising:
configuring a first device with an authentication chip having a public authentication key, a private authentication key and data signed by a private verification key;
storing a public verification key on a second device;
communicatively coupling the first device to the second device;
reading the data and the public authentication key from the first device by the second device;
determining whether the data and the public authentication key are verified using the public verification key; and
determining whether the first device is authenticated for use with the second device using an elliptic curve cryptographic algorithm if the data and the public authentication key are verified.

8. The method of claim 7, wherein configuring a first device comprises storing the public authentication key, the private authentication key and the data signed by the private verification key in a memory of the authentication chip.

9. The method of claim 7, further comprising:
creating a signature; and
storing the signature on the authentication chip as at least part of the data.

10. The method of claim 9, wherein creating the signature comprises:
assembling a message;
hashing the message to create a digest; and
signing the digest with the private verification key.

11. The method of claim 10, wherein hashing the message comprises using an SHA cryptographic hash algorithm.

12. The method of claim 11, wherein the SHA cryptographic hash algorithm is one of an SHA-1 or an SHA-256 cryptographic hash algorithm.

13. The method of claim 9, wherein assembling a message comprising concatenating an identifier related to the first device, the public authentication key, and optional data.

14. The method of claim 9, wherein assembling the message comprises matching an identifier related to the first device, the public authentication key, and optional data to a certificate template.

15. The method of claim 14, wherein the certificate template is an X.509 certificate template.

16. The method of claim 7, wherein determining whether the data is verified comprises:
recreating a message from the data read from the first device by the second device;
hashing the recreated message to determine a first digest;
extracting a second digest from the data read from the first device by the second device; and
comparing the first and second digests by the second device.

17. The method of claim 16, wherein extracting the second digest comprises using the public verification key.

18. A semiconductor chip adapted to be embedded in a first device, comprising:
a memory comprising a private authentication key, a public authentication key, and data signed by a private verification key, wherein the private authentication key is stored in a secure portion of the memory; and
a communication interface configured to communicate with a second device comprising a public verification key using an asymmetric cryptographic technique.

19. A microcontroller comprising:
circuitry configured to store a private authentication key, a public authentication key, and data signed by a private verification key; and
communication circuitry configured to communicate the public authentication key and the data, to receive a challenge encrypted with the public authentication key, and to communicate a response related to the encrypted challenge unencrypted with the private authentication key.

20. A method comprising:
reading a public authentication key from a first device by a second device;
verifying the public authentication key using a public verification key stored on the second device and data stored on the first device and signed by a private verification key;
encrypting a challenge with the public authentication by the second device;
sending the encrypted challenge to the first device;
decrypting the challenge using a private authentication key by the first device;
sending a response by the first device to the second device; and
evaluating the response by the second device to determine whether the first device is authenticated.

21. The method of claim 20, further comprising establishing cooperation between the first and second devices if the first device is authenticated.

22. The method of claim 20, further comprising at least partially disabling cooperation between the first and second devices if the first device is not authenticated.

23. The method of claim 20, wherein the first device is one of a component or an accessory of the second device.

24. The method of claim 20, further comprising providing the public verification key to the second device.

25. The method of claim 20, further comprising signing the data by a holder of the private verification key.
